(19) United States
(12) Patent Application Publication
(10) Pub. No.: US 2008/0186168 A1
(43) Pub. Date: Aug. 7, 2008

(54) ELECTRONIC SYSTEM FOR CONTROLLING GATE OR DOOR OPENING

(75) Inventor: Fabrizio Di Saverio, San Nicolo a Tordino (TE) (IT)

Correspondence Address: ROBERTS MLOTKOWSKI SAFRAN & COLE, P.C., P. O. BOX 10064, MCLEAN, VA, 22102-8064, US

(73) Assignee: FINDISA S.R.L., San Nicolo A Tordino (TE) (IT)

(21) Appl. No.: 11/671,246

(22) Filed: Feb. 5, 2007

(51) Int. Cl. G08B 21/00

(52) U.S. Cl. 340/540

(57) ABSTRACT

The invention concerns an electronic system for controlling gate or door opening, capable to control means for moving two or more wings comprising at least one master electronic unit, and at least one slave electronic unit, capable of controlling a respective portion of said movement means said at least one master electronic unit and said at least one slave electronic unit communicating with each other through at least one two-way communication channel established between at least one first transceiver device, connected to said at least one master electronic unit, and at least one second transceiver device, connected to said at least one slave electronic unit, said at least one two-way communication channel being selected from the group comprising a wireless optical channel, a wireless radiofrequency channel, a wireless electromagnetic channel, a wireless ultrasound channel, and a power line channel.

The present invention relates to an electronic system for controlling gates or doors, in particular having two or more wings, with automatic opening, for vehicle and/or pedestrian passage, that allows automatic opening gates to be installed in a simple, reliable, safe and inexpensive way, the system being easily integratable with the structure wherein it is installed.

In the following, the system according to the invention will be described with reference to its application to automatic opening gates, but it should be understood that it may be applied to other automatic opening apparatuses for delimiting rooms and spaces, such as doors, still remaining within the scope of the present invention.

It is known that systems for opening two-wing gates or doors requires a synchronisation among two or more automatic sub-systems, which operate in a specific sequence, each one of which controls a corresponding wing. Such synchronisation entails the installation of one or more connections and wirings among the same.

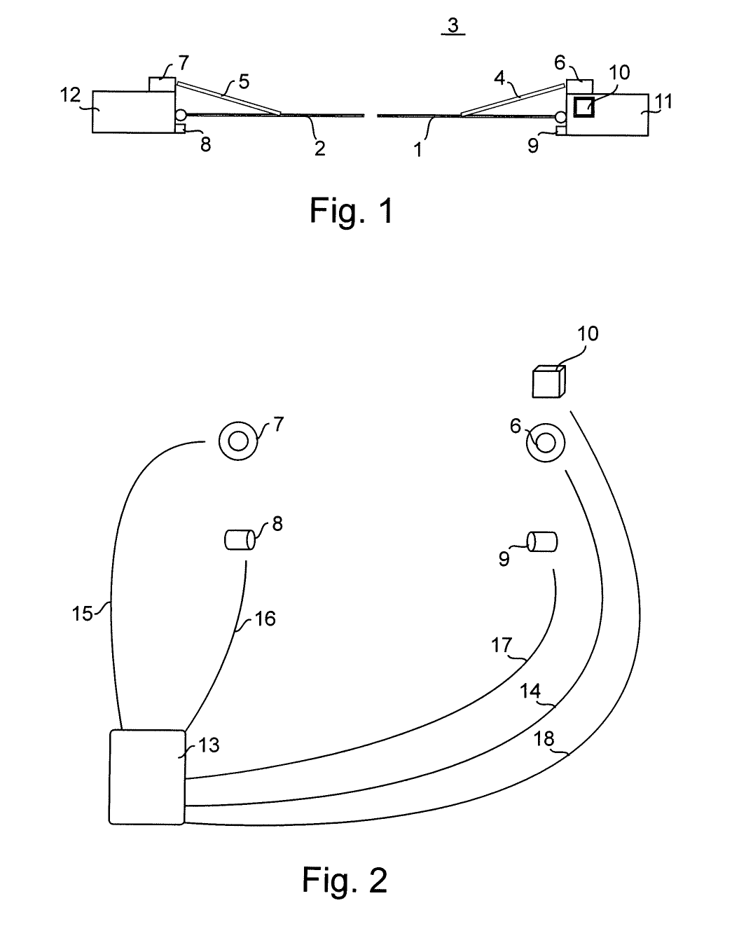

By way of example, FIG. 1 shows a gate having two wings, respectively right 1 and left 2 (looking at the gate from outside the zone 3 delimited by the same), pivoted on a respective post, 11 and 12. Each one of the two wings 1 and 2 is moved by a respective mechanical arm, 4 and 5, coupled to the corresponding wing, 1 or 2, and operated by a respective electric motor, 6 and 7, so as to open or close the corresponding wing, 1 or 2. The system further comprises an infrared or IR transmitter 8 and an IR receiver 9, facing each other so as to form an infrared ray barrier operating as anti-collision detector for persons and vehicles which possibly pass during gate movement. Finally, the system of FIG. 1 still comprises a light signalling device, in particular a flasher 10, that flashes during the movement of the two wings 1 and 2.

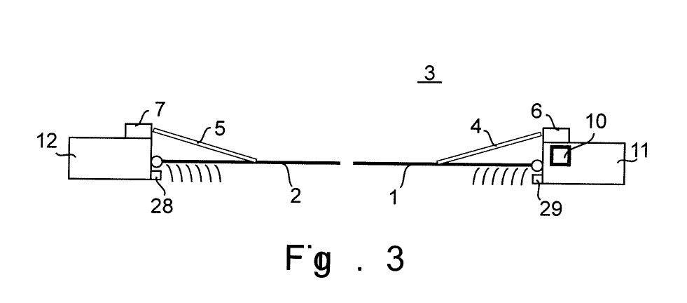

FIG. 2 shows electrical connections among the various components of the system of FIG. 1 that is necessary to make in order to install the same system. In particular, the system comprises an electronic unit 13, located in correspondence with one of the two posts 11 and 12 of FIG. 1, that controls the motor 6 and the motor 7 in a synchronised way, through corresponding wirings 14 and 15, that interprets detections made by IR transmitter 8 and IR receiver 9, which are received through corresponding wirings 16 and 17, and that controls the flasher 10, through a corresponding wiring 18.

Considering that other electronic systems and/or other configurations of electronic systems (for instance, multiple master/slave ones) for controlling gate or door opening require similar connections among several components, it is evident that present control electronic systems suffer from significant drawbacks due to the complexity of installation of wirings among the electronic unit and the motors operating the wing mechanical arms, and among the electronic unit and several mandatory safety devices, usually imposed by law provisions, such as the flasher and the IR barrier.

First of all, in most cases, automatic opening systems for gates or doors must be installed within structures which are not prearranged during the design phase to be provided with such.

Moreover, since, due to practical and/or aesthetic reasons, in nearly all real cases it is not possible to make an aerial connection, it is necessary to make an underground cable duct (in particular electrical pipes according to EN provisions on AC high voltage systems) between the post on which the box 13 is installed and the other post. Considering that a driveway is usually located between the two wings, this entails significant inconveniences for both the use of the driveway and the installation of the control system.

Still, often such control electronic systems cannot be installed due to the fact that the structures which are to house them do not allow to make such connections. For instance, it is this the case of structures of particular artistic or monumental relevance, such as driveways in ancient buildings.

Furthermore, the connection cables between the unit 13 and the various system components are often specific for each component, thus increasing complexity and costs of the installation of the system. For instance, the IR transmitter 8 and the IR receiver 9 are connected by a specific multicore cable.

Still, the installation of the electronic system requires the work of specialised technical personnel, capable, for instance, to operate with live terminals and to carry out adjustment by means of trimmers located on an electronic board, usually internal to an outdoor sealed housing. This increases complexity and cost of installation and maintenance of the system.

Finally, complexity of wiring installation represents a not negligible cost, often higher than that of the same system.

It is therefore an object of the present invention to provide electronic systems for controlling gates or doors, in particular having two or more wings, with automatic opening, which are reliable and safe and which may be installed in a simple, fast and inexpensive way, the system being easily integratable with the structure wherein it is installed.

It is specific subject matter of this invention an electronic system for controlling gate or door opening, capable to control means for moving two or more wings, characterised in that it comprises at least one master electronic unit, and at least one slave electronic unit, capable to control a respective portion of said movement means, said at least one master electronic unit and said at least one slave electronic unit communicating with each other through at least one two-way communication channel established between at least one first transceiver device, connected to said at least one master electronic unit, and at least one second transceiver device, connected to said at least one slave electronic unit, said at least one two-way communication channel being selected from the group comprising a wireless optical channel, a wireless radiofrequency channel, a wireless electromagnetic channel, a wireless ultrasound channel, and a power line channel.

Preferably according to the invention, at least one master electronic unit is capable to control a synchronisation of at least one respective portion of said means for moving said two or more wings.

Always according to the invention, at least one master electronic unit may be capable to control a respective portion of said movement means.

Still according to the invention, the system may comprise receiver means capable to receive at least one signal generated by a remote control and/or a transponder, said at least one master electronic unit capable to control said synchronisation of at least one respective portion of said means for moving said two or more wings setting, when said receiver means receives at least one signal generated by a remote control and/or a transponder, one or more mode of operating said movement means.

Furthermore according to the invention, said two or more wings may comprise at least one sliding wing and/or at least one revolving wing, and/or at least one sliding wing and/or at least one tilting wing.

Further embodiments of the system according to the invention are described in dependent claims 2-15.

The present invention will be now described, by way of illustration and not by way of limitation, according to its preferred embodiments, by particularly referring to the Figures of the enclosed drawings, in which:

FIG. 1 shows a schematic top view of a gate provided with a control electronic system according to the prior art;

FIG. 2 shows a schematic block diagram of the components of the system of FIG. 1;

FIG. 3 shows a schematic top view of a gate provided with a preferred embodiment of the control electronic system according to the invention; and

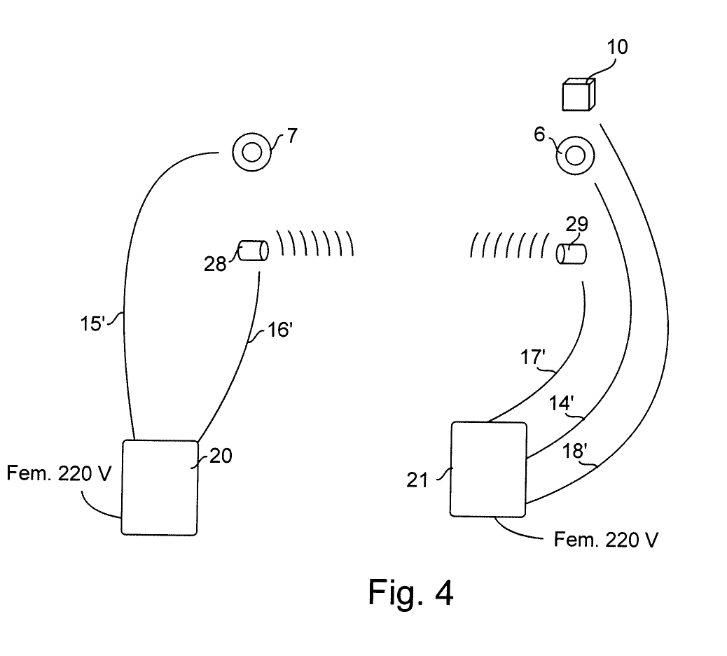

FIG. 4 shows a schematic block diagram of the components of the system of FIG. 3.

In the following of the description same reference numbers will be used for indicating alike elements in the Figures.

With reference to FIGS. 3 and 4, it may be observed that the preferred embodiment of the system according to the invention is still applied to a gate having two wings, respectively a right one 1 and a left one 2 (looking at the gate from the outside of the zone 3 delimited by the gate), pivoted on a respective post, 11 and 12, each one of which is moved by a respective mechanical arm, 4 and 5, operated by a respective electric motor, 6 and 7.

The system of FIGS. 3 and 4, also provided with a flasher 10, further comprises a first IR transceiver 28 and a second IR transceiver 29, facing each other so as to form an infrared ray barrier for anti-collision detections.

As shown in FIG. 4, the system according to the invention comprises a first master electronic unit 20, that controls motor 7 operating the mechanical arm 5 coupled to the left wing 2, and a second slave electronic unit 21, that controls motor 6 operating the mechanical arm 4 coupled to the right wing 1 and to the flasher 10.

The first and the second IR transceivers 28 and 29, respectively connected to the master unit 20 and slave unit 21, are the terminals of the infrared wireless two-way communication channel capable to exchange control digital signals between the master unit 20 and the slave unit 21.

In particular, the master unit 20 preferably comprises at least one microprocessor (possibly in multiprocessor configuration) that also controls the operation of the slave unit 21 (still preferably comprising at least one microprocessor, possibly in multiprocessor configuration), by sending suitable encoded commands and receiving information signals (for instance related to the state of slave unit 20, motor 6, or flasher 10), through the infrared communication channel established by the first and second IR transceivers 28 and 29, specifically for controlling synchronisation of motors 6 and 7 and, hence, movements of the wings 1 and 2.

In this way, it is no more necessary to make wirings connecting the several components of the system placed in correspondence with the two gate posts 11 and 12 (as instead the case is, for instance, for the connection between unit 13 and motor 6 of the prior art system of FIGS. 1 and 2). In fact, it is sufficient to make connections 15′ and 16′ (local to the left post 12) between master unit 20 and, respectively, motor 7 and first IR transceiver 28, and similar connections 14′, 17′, and 18′ (local to the right post 11) between slave unit 21 and, respectively, motor 6, second IR transceiver 29, and flasher 10. In particular, master unit 20 and slave unit 21 are power supplied by respective electrical energy sources, such as respective outlets present, for instance sue to lighting reasons, in proximity of both gate posts 11 and 12. Alternatively (or additionally), master and slave units 20 and 21 may be power supplied at least partially through solar panels and/or batteries; in particular, the first and/or the second IR transceivers 28 and 29 may be power supplied through solar panels and/or batteries.

Other embodiments of the system according to the invention may comprise a different arrangement and/or composition of the various system components. For instance, the flasher 10 of FIGS. 3 and 4 (or a second visual signalling device) could be mounted on the left post 12 and directly controlled by the master unit 20; otherwise, other safety devices, for instance acoustic signalling devices, could be mounted on either one or both gate posts 11 and 12.

Other embodiments of the system according to the invention may comprise, alternatively or additionally to the infrared one established by first and second IR transceivers 28 and 29 of FIGS. 3 and 4, different wireless two-way communication channels. For instance, a wireless, preferably infrared or laser, optical channel could comprise a transceiver device integrated into the flasher 10, capable to communicate with the first IR transceiver 28 or a different device, facing the flasher 10 and mounted on the left post 12. Other embodiments may comprise radio wave transceiver devices, such as for instance WI-FI, GSM/GPRS, or Bluetooth, rather than infrared, ones. Furthermore, a two-way communication channel between master unit 20 and slave unit 21 may be established through waves conveyed over the preferably pre-existing mains (power line channel). Still, the wireless communication channel between master unit 20 and slave unit 21 may be established by means of ultrasound capsules. Furthermore, the wireless communication channel may be established through magnetic or variable reluctance electromagnetic devices.

Other embodiments of the system according to the invention may control automatic closing apparatuses including a plurality of portions which may be moved independently of each other, and which need a synchronisation control. For instance, gates comprising a plurality of wings, or complex apparatuses comprising a plurality of gates. In this case, the system according to the invention may comprise more than one master unit and/or more than one slave unit, each one of which operates similarly to the units 20 and 21 of the system of FIGS. 3 and 4, communicating with one or more of the other units (preferably a main master unit controls the synchronisation of the whole system).

Moreover, the system according to the invention may comprise various methods for activating the automatic opening, for instance two different motor drives both using a respective receiver of a signal generated by a remote control or a transponder.

Preferably, the system according to the invention provides that all the electrical connections and adjustments of the system, necessary for installation, test, calibration, and maintenance, are capable to be made directly by the end user, even without any specific skill, who, not having to directly operate on the internal components, is able to autonomously operate on the system.

The advantages offered by the system according to the invention are evident.

First of all, thanks to the presence of master unit 20 and slave unit 21, indirectly connected to each other, preferably through a wireless channel, it is no more necessary to underground cables (related to power supply, signal communication, and other requirements) between the two gate posts. This entails evident advantages, in particular in case of a driveway, in terms of costs, short installation time, and lack of impact on the pre-existing structure.

The present invention has been described, by way of illustration and not by way of limitation, according to a preferred embodiment thereof, but it should be understood that those skilled in the art can make variations and/or changes, without so departing from the related scope of protection, as defined by the enclosed claims.

1-15. (canceled)

16. An electronic system for controlling gate or door opening, capable to control means for moving two or more wings, comprising at least one master electronic unit, and at least one slave electronic unit, capable to control a respective portion of said movement means, said at least one master electronic unit and said at least one slave electronic unit communicating with each other through at least one two-way communication channel established between at least one first transceiver device, connected to said at least one master electronic unit, and at least one second transceiver device, connected to said at least one slave electronic unit, said at least one two-way communication channel being selected from the group comprising a wireless optical channel, a wireless radiofrequency channel, a wireless electromagnetic channel, a wireless ultrasound channel, and a power line channel.

17. A system according to claim 16, comprising at least one master electronic unit is capable to control a synchronisation of at least one respective portion of said means for moving said two or more wings.

18. A system according to claim 16, comprising at least one master electronic unit capable to control a respective portion of said movement means.

19. A system according to claim 16, wherein said at least one first transceiver device and said at least one second transceiver device are infrared or IR devices, whereby said at least one two-way communication channel is a wireless IR optical channel.

20. A system according to claim 19, wherein said at least one first IR transceiver device and said at least one second IR transceiver device are facing each other so as to form an infrared ray barrier operating as a detector of persons and/or objects passing between the same.

21. A system according to claim 16, wherein said at least one first transceiver device and said at least one second transceiver device are laser devices, whereby said at least one two-way communication channel is a wireless laser optical channel.

22. A system according to claim 16, wherein said at least one first transceiver device and said at least one second transceiver device are radio wave devices, whereby said at least one two-way communication channel is a wireless radiofrequency, preferably WI-FI and/or GSM/GPRS and/or Bluetooth, channel.

23. A system according to claim 16, wherein said at least one first transceiver device and said at least one second transceiver device comprise ultrasound capsules, whereby said at least one two-way communication channel is a wireless ultrasound channel.

24. A system according to claim 16, wherein said at least one first transceiver device and said at least one second transceiver device are variable reluctance electromagnetic devices, whereby said at least one two-way communication channel is a wireless electromagnetic channel.

25. A system according to claim 16, wherein said at least one first transceiver device and said at least one second transceiver device are devices receiving-transmitting waves conveyed over a mains, whereby said at least one two-way communication channel is a power line channel.

26. A system according to claim 16, wherein said movements means comprises at least one mechanical arm, coupled to at least one respective wing, operated by at least one corresponding motor.

27. A system according to claim 17, which further comprises receiver means capable to receive at least one signal generated by a remote control and/or a transponder, said at least one master electronic unit capable to control said synchronisation of at least one respective portion of said means for moving said two or more wings setting, when said receiver means receives at least one signal generated by a remote control and/or a transponder, one or more mode of operating said movement means.

28. A system according to claim 16, wherein said at least one master electronic unit and/or said at least one slave electronic unit comprise at least one microprocessor.

29. A system according to claim 16, which further comprises acoustic and/or visual signalling means, controlled by said at least one master electronic unit.

30. A system according to claim 16, wherein said two or more wings comprise at least one sliding wing and/or at least one revolving wing, and/or at least one sliding wing and/or at least one tilting wing.
